(19) United States
(12) Patent Application Publication
(10) Pub. No.: US 2005/0034171 A1
(43) Pub. Date: Feb. 10, 2005

(54) Technique for delivering programming content based on a modified network personal video recorder service

(76) Inventor: Robert Benya, Breezy Point, NY (US)

Correspondence Address: ALEX L. YIP;KAYE SCHOLER LLP, 425 PARK AVENUE, NEW YORK, NY, 10022, US

(21) Appl. No.: 10/913,064

(22) Filed: Aug. 6, 2004

Related U.S. Application Data
(63) Continuation-in-part of application No. 10/302,550, filed on Nov. 22, 2002.
(60) Provisional application No. 60/377,963, filed on May 3, 2002.

(51) Int. Cl. H04N 7/173; H04N 7/16; H04B 1/66

(52) U.S. Cl. 725/143; 725/134; 725/142

(57) ABSTRACT

A network personal video recorder (NPVR) service is modified so that some or all of the programs on an NPVR enabled channel are deprived of a fast-forward capability otherwise afforded by the NPVR service. As a result, a user cannot fast-forward one such program to skip commercials and product placement advertisements therein. In addition, some or all of the programs on an NPVR enabled channel cannot be freely time-shifted without regard for their broadcast schedule. Rather, in an illustrative embodiment, the end time of one such program is restrictively extended past its scheduled end time.

The present application is a continuation-in-part of U.S. application Ser. No. 10/302,550 filed on Nov. 22, 2002, which claims the benefit of Provisional Application Ser. No. 60/377,963 filed on May 3, 2002, both of which are incorporated herein by reference.

### FIELD OF THE INVENTION

The invention relates to communications systems and methods, and more particularly to a system and method for delivering entertainment programs through a communications network, e.g., a cable TV network.

### BACKGROUND OF THE INVENTION

With the advent of digital communications technology, many TV program streams are transmitted in digital formats. For example, Digital Satellite System (DSS), Digital Broadcast Services (DBS), and Advanced Television Standards Committee (ATSC) program streams are digitally formatted pursuant to the well known Moving Pictures Experts Group 2 (MPEG-2) standard. The MPEG-2 standard specifies, among others, the methodologies for video and audio data compressions which allow multiple programs, with different video and audio feeds, multiplexed in a transport stream traversing a single transmission channel. A digital TV receiver may be used to decode an MPEG-2 encoded transport stream, and extract the desired program therefrom.

### MPEG-2 BACKGROUND

In accordance with the MPEG-2 standard, video data may be compressed based on a sequence of groups of pictures (GOPs), made up of three types of picture frames—intra-coded picture frames (“I-frames”), forward predictive frames (“P-frames”) and bilinear frames (“B-frames”). Each GOP may, for example, begin with an I-frame which is obtained by spatially compressing a complete picture using discrete cosine transform (DCT). As a result, if an error or a channel switch occurs, it is possible to resume correct decoding at the next I-frame.

The GOP may represent additional frames by providing a much smaller block of digital data that indicates how small portions of the I-frame, referred to as macroblocks, move over time.

An I-frame is typically followed by multiple P- and B-frames in a GOP. Thus, for example, a P-frame occurs more frequently than an I-frame by a ratio of about 3 to 1. A P-frame is forward predictive and is encoded from the I- or P-frame that precedes it. A P-frame contains the difference between a current frame and the previous I- or P-frame.

A B-frame compares both the preceding and subsequent I- or P-frame data. The B-frame contains the average of matching macroblocks or motion vectors. Because a B-frame is encoded based upon both preceding and subsequent frame data, it effectively stores motion information.

Thus, MPEG-2 achieves its compression by assuming that only small portions of an image change over time, making the representation of these additional frames extremely compact. Although GOPs have no relationship between themselves, the frames within a GOP have a specific relationship which builds off the initial I-frame.

The compressed video and audio data are carried by continuous elementary streams, respectively, which are broken into access units or packets, resulting in packetized elementary streams (PESs). These packets are identified by headers that contain time stamps for synchronizing, and are used to form MPEG-2 transport streams. For digital broadcasting, multiple programs and their associated PESs are multiplexed into a single transport stream. A transport stream has PES packets further subdivided into short fixed-size data packets, in which multiple programs encoded with different clocks can be carried. A transport stream not only comprises a multiplex of audio and video PESs, but also other data such as MPEG-2 program specific information (sometimes referred to as metadata) describing the transport stream. The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption) and this information is also carried in the MPEG-2 transport stream, possibly as metadata.

The aforementioned fixed-size data packets in a transport stream each carry a packet identifier (PID) code. Packets in the same elementary streams all have the same PID, so that a decoder can select the elementary stream(s) it needs and reject the remainder. Packet-continuity counters may be implemented to ensure that every packet that is needed to decode a stream is received.

Use of digital video recorders (DVRs), also known as personal video recorders (PVRs), such as TiVo and ReplayTV devices, is ubiquitous, which provide conveniences to TV viewers. For example, a prior art DVR allows a user to record his/her favorite TV programs for later review, and exercise a season-pass-like option to record every episode of his/her favorite program for a period. It may automatically record programs for the user based on his/her viewing habit and preferences. The presentation of the recorded programming content can be manipulated by exercising rewind, pause and fast-forward functions (hereinafter referred to as “trick mode” functions) furnished by the DVR.

The cable TV industry has been fervently pursuing a “network PVR (NPVR)” service allowing the user to perform the analogous DVR functions through use of a network, rather than a local DVR at the user premises. In fact, a network architecture and functionalities for implementing the NPVR service have been developed and are described, e.g., in copending commonly assigned U.S application Ser. No. 10/302,550, filed on Nov. 22, 2002, hereby incorporated by reference. For example, unlike a DVR device, the NPVR service allows a user to “reserve” past and future programs for his/her review, even if such reserved programs were not identified by the user before their broadcast.

### SUMMARY OF THE INVENTION

The present invention improves the aforementioned NPVR service to address concerns of network broadcasting service companies (NBSCs), e.g., Columbia Broadcasting Service (CBS) Company, American Broadcasting Company (ABC), etc. The revenue income of such NBSCs principally is derived from commercials, punctuating the programs provided thereby. As is well known, a TV show is typically interrupted by commercial breaks during which commercials are played. An NBSC sells commercial time slots to advertisers for placing commercials therein. The price of a commercial time slot varies with an anticipated size of an audience of a TV show associated therewith, stemming from the assumption that the same audience would watch the commercial placed in such a time slot. That is, the more popular the show is, the more pricey the commercial time slots associated with the show.

Recently, product placement advertisements became common for which advertisers pay to place a commercial product on a show. For example, a product placement advertisement may involve an actor drinking from a Coca-Cola® can on a TV show, with the Coca-Cola® logo ostensibly shown, thereby advertising the Coca-Cola® drink. For similar reasons, the price for one such product placement advertisement varies with the popularity of the show associated therewith.

The majority of the population watches TV between 8:00 pm and 11:00 pm on weeknights, i.e., after dinner and before bedtime, also known as TV prime time. To vie for a large share of TV viewers, NBSCs typically line up popular shows for display during the TV prime time, also known as a prime time lineup. The invention is premised upon a recognition that deployment of the NPVR service may adversely affect NBSCs' return of their investment in a prime time lineup, which normally calls for a large budget to produce. This stems from the fact that the NPVR service removes the traditional broadcast schedule constraint, and allows a user to view a program at a time of his/her choice. Thus, an NPVR user can view programs in a prime time lineup not necessarily during the TV prime time. The cumulative effect is that even if the programs in a prime time lineup are popular, there is no guarantee of a large audience during the TV prime time. As a result, advertisers may be unwilling to pay a premium for commercial time slots in the TV prime time.

The invention is premised upon another recognition that the fast-forward trick mode function afforded by the NPVR service may also negatively affect the advertising income of an NBSC. Using such a trick mode function, an NPVR user may fast-forward a TV program to skip commercials therein, or portions of a show which may contain product placement advertisements, thus rendering such commercials and advertisements ineffective. Unfortunately for NBSCs, advertisers are not willing to pay much for ineffective commercials and advertisements.

The invention improves the NPVR service by modifying aspects thereof. In accordance with an aspect of the invention, a subset of the programs provided on a selected program channel is identified. When a fast-forward command is received from a device for presenting a selected program on the selected program channel to a user, a determination is made whether the selected program is one of the identified programs in the subset. If so, the inventive service does not respond to the fast-forward command, rendering the fast-forward command ineffective.

In accordance with another aspect of the invention, programs are provided on a selected program channel according to a broadcast schedule, a subset of which (e.g., programs in a prime time lineup) is identified. When a command is received from a device over a communications network for manipulating a presentation of a selected program on the selected program channel, a determination is made whether the selected program is one of the identified programs in the subset. If so, a presentation time of the selected program, presented using the device, is adjusted as a function of the broadcast schedule. For example, the presentation end time of the selected program may be extended past its scheduled end time.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1 is a block diagram of a broadband communications system in accordance with the invention;

FIG. 2 illustrates a TV program comprising multiple program segments which is provided in the system of FIG. 1;

FIG. 3 illustrates a request for program material from a set-top terminal in the system of FIG. 1;

FIG. 4 is a flow chart depicting a process for providing program material in response to the request of FIG. 3;

FIG. 5 illustrates selected carriers for transmitting program materials in a forward passband of the system of FIG. 1;

FIG. 6 is a flow chart depicting a process for pausing a program in response to a pause message from a set-top terminal;

FIG. 7 is a flow chart depicting a process for rewinding a program in response to a rewind message from a set-top terminal;

FIG. 8 is a flow chart depicting a process for fast-forwarding a program in response to a fast-forward message from a set-top terminal;

FIG. 9 is a block diagram of a set-top terminal;

FIG. 10 illustrates screen displays in accessing a Look Back GUI in accordance with a first embodiment;

FIG. 11 illustrates screen displays in accessing a Look Back GUI in accordance with a second embodiment;

FIG. 12 illustrates screen displays in accessing a Look Back GUI in accordance with a third embodiment;

FIG. 13 is a flow chart depicting a process where selected programs are not afforded a fast-forward capability, in accordance with the invention; and

FIG. 14 is a flow chart depicting a process for serving selected programs in accordance with the invention.

### DETAILED DESCRIPTION

The invention is directed to delivering programming content to users through a broadband communications network, e.g., a cable TV network. Selected programs or program channels may be afforded a network personal video recorder (NPVR) service to enhance a user's enjoyment of programming content. In accordance with the NPVR service, broadcast programs (or at least those broadcast programs afforded the NPVR service) are recorded at a headend of a cable network when they are delivered to a user at a set-top terminal. Thus, the user not only may “reserve” for review a future program and a previously broadcast program, but also restart an in-progress program since it has been recorded at the headend regardless of any user request. That is, the NPVR service obviates the need of a proactive effort otherwise required of a typical DVR user, which includes deciding and actively electing in advance what shows to record. In addition, the NPVR service furnishes trick mode functions (e.g., rewind, pause and fast-forward functions) for manipulating a presentation of recorded programming content.

The present invention improves the NPVR service to address concerns of network broadcasting service companies (NBSCs), e.g., Columbia Broadcasting Service (CBS) Company, American Broadcasting Company (ABC), etc. The revenue income of such NBSCs principally is derived from commercials, punctuating the programs provided thereby. As is well known, a TV show is typically interrupted by commercial breaks during which commercials are played. An NBSC sells commercial time slots to advertisers for placing commercials therein. The price of a commercial time slot varies with an anticipated size of an audience of a TV show associated therewith, stemming from the assumption that the same audience would watch the commercial placed in such a time slot. That is, the more popular the show is, the more pricey the commercial time slots associated with the show.

Recently, product placement advertisements became common for which advertisers pay to place a commercial product on a show. For example, a product placement advertisement may involve an actor drinking from a Coca-Cola® can on a TV show, with the Coca-Cola® logo ostensibly shown, thereby advertising the Coca-Cola® drink. For similar reasons, the price for one such product placement advertisement varies with the popularity of the show associated therewith.

The majority of the population watches TV between 8:00 pm and 11:00 pm on weeknights, i.e., after dinner and before bedtime, also known as TV prime time. To vie for a large share of TV viewers, NBSCs typically line up popular shows for display during the TV prime time, also known as a prime time lineup. The invention is premised upon a recognition that deployment of the NPVR service may adversely affect NBSCs' return of their investment in a prime time lineup, which normally calls for a large budget to produce. This stems from the fact that the NPVR service removes the traditional broadcast schedule constraint, and allows a user to view a program at a time of his/her choice. Thus, an NPVR user can view programs in a prime time lineup not necessarily during the TV prime time. The cumulative effect is that even if the programs in a prime time lineup are popular, there is no guarantee of a large audience during the TV prime time. As a result, advertisers may be unwilling to pay a premium for commercial time slots in the TV prime time.

The invention is premised upon another recognition that the fast-forward trick mode function afforded by the NPVR service may also negatively affect the advertising income of an NBSC. Using such a trick mode function, an NPVR user may fast-forward a TV program to skip commercials therein, or portions of a show which may contain product placement advertisements, thus rendering such commercials and advertisements ineffective. Unfortunately for NBSCs, advertisers are not willing to pay much for ineffective commercials and advertisements.

The invention improves the NPVR service by modifying aspects thereof. In accordance with the invention, some or all programs afforded an NPVR service or on an NPVR enabled channel, especially those shown during the TV prime time, may not be afforded all of the NPVR service features. For example, a user may not be able to fast-forward one such program during its broadcast. In addition, a user may not be able to use the aforementioned NPVR reservation capability to freely time-shift a broadcast program for later viewing, without regard for its broadcast schedule. Rather, in accordance with an aspect of the invention, a program afforded an inventive “Prime Time On Demand (PTOD)” service (hereinafter referred to as a PTOD program) is partly subject to its broadcast schedule. In an illustrative embodiment described below, the end time of a PTOD program may be restrictively extended beyond its broadcast schedule.

In order to fully appreciate the PTOD service in accordance with the invention, one needs to learn about the NPVR service, an implementation of which will now be described:

### NPVR Service Implementation

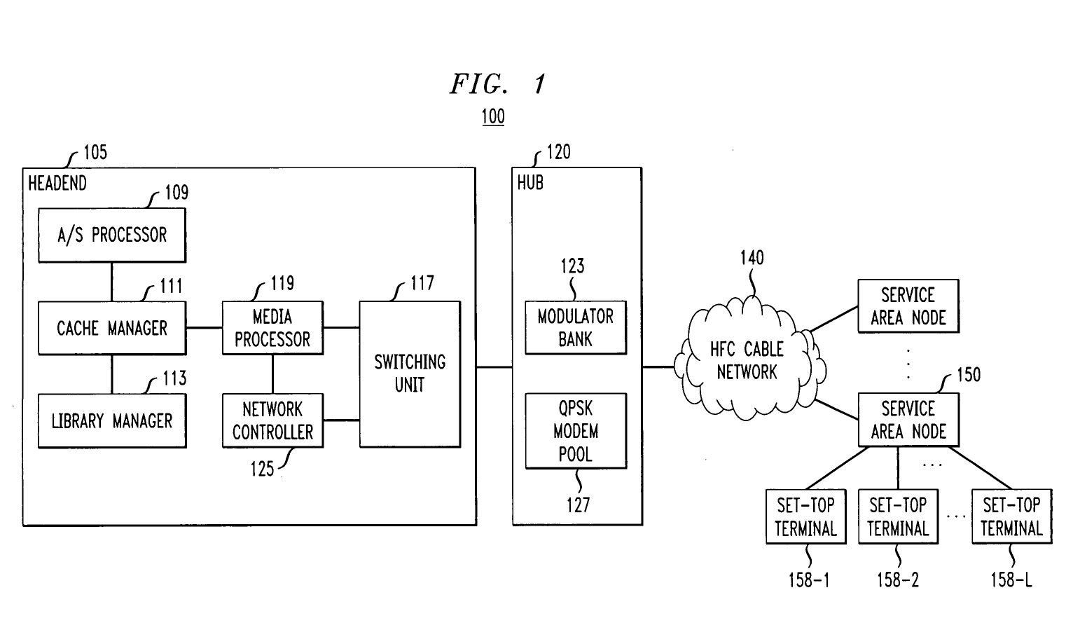

FIG. 1 illustrates broadband communications system 100 for providing the NPVR service, which is readily modifiable to provide the inventive PTOD service based on the disclosure hereinbelow. For example, system 100 in this instance includes a cable system for delivering information and entertainment programs to set-top terminals on the user premises. As shown in FIG. 1, system 100 includes headend 105, hub 120, hybrid fiber coax (HFC) cable network 140 and different service area nodes including node 150, which in this instance is connected to set-top terminals 158-1 through 158-L in a neighborhood, where L represents an integer.

Headend 105 receives programs and services from various providers and sources, e.g., analog and digital satellite sources, application servers, media servers, the Internet, etc. Analog and digital satellite sources typically provide the traditional forms of television broadcast programs and information services. Application servers typically provide executable code and data for application specific services such as database services, network management services, transactional electronic commerce services, system administration console services, application specific services (such as stock ticker, sports ticker, weather and interactive program guide data), resource management service, connection management services, subscriber cares services, billing services, operation system services, and object management services. Media servers provide time-critical media assets such as MPEG-2 encoded video and audio, MPEG-2 encoded still images, bit-mapped graphic images, PCM digital audio, three dimensional graphic objects, application programs, application data files, etc. Although specific examples of programs and services which may be provided by the aforementioned sources are given herein, other programs and services may also be provided by these or other sources.

Acquisition/Staging (A/S) processor 109 in headend 105 processes program materials including, e.g., TV program streams, from one or more of the aforementioned sources in analog and digital forms. Analog TV program streams may be formatted according to the National Television Standards Committee (NTSC) or Phase Alternating Line (PAL) broadcast standard. Digital TV streams may be formatted according to the Digital Video Broadcasting (DVB), Society of Cable Telecommunications Engineers (SCTE), or Advanced Television Systems Committee (ATSC) standards. Processor 109, among other things, extracts program content in the analog and digital TV streams and reformats the content to form one or more MPEG-2 encoded transport streams. Such reformatting may even be applied to those received streams already in an MPEG-2 format. This stems from the fact that the digital content in the received MPEG-2 streams are typically encoded at a variable bit rate (VBR). To avoid data burstiness, processor 109 in a conventional manner re-encodes such digital content at a constant bit rate (CBR) to form the aforementioned transport streams.

An MPEG-2 transport stream contains multiple program streams with different video and audio feeds multiplexed for transmission through the same transmission channel. The program streams representing individual programs are identified by respective program identifications (IDs) within a transport stream. It should be noted at this point that the term “transmission channel” should not be confused with a “program channel.” A “transmission channel” signifies a designated frequency band through which a transport stream is transmitted. On the other hand, a “program channel” signifies the source of the program material selected by a user to view. For example, a user may select program channel 2 to view program material provided by CBS, program channel 23 to view program material provided by HBO; program channel 32 to view program material provided by MTV, etc.

In this illustrative embodiment, the transmission channels, each carrying a transport stream, may be 6 MHz bands populating a forward passband, e.g., 350-750 MHz band, of a coaxial cable, which is allocated for downstream communication from headend 105 to a set-top terminal.

A/S processor 109 may receive “assets” including pre-staged movie videos, news reports, sports events, etc. from content providers. However, processor 109 may also create “assets” in real time while processing received program materials which are not pre-staged by the content providers. In general, an “asset” is a container for any object or set of objects that may be desired to implement a service, including video, audio, images, application executables, scripts, configuration files, text, fonts, and HTML pages (or pointers referencing their storage locations). In addition to the raw content, metadata is also a part of an asset object that describes characteristics of the asset. For example, asset metadata may describe attributes that are inherent in the content of the asset, such as the rating, format, duration, size, or encoding method. Values for asset metadata are determined at the time the asset is created.

An asset concerning a program may include trick files associated with the program as well. FIG. 2 illustrates TV program 201 which spans from 7:00 p.m. to 7:30 p.m. Program 201 comprises a show interrupted by commercials, which is typical. Thus, the program content in this instance consists of show segments 231, 233 and 235, interleaved with commercial segments 221 and 227. The TV program streams received by processor 109 are pre-processed, e.g., by the providers, to include indicators, e.g., cue-tones, on which processor 109 relies to identify the demarcations (or edges) of different programs and program segments within each program. Thus, in this instance before processor 109 processes the TV program stream containing TV program 201, a first cue-tone has been inserted at the beginning of segment 231, indicating the beginning of TV program 201; second cue-tones have been inserted at the beginnings of segments 221 and 227, indicating the beginnings of the respective commercial segments; third cue-tones have been inserted at the ends of segments 221 and 227, indicating the ends of the respective commercial segments; and a fourth cue-tone has been inserted at the end of segment 235, indicating the end of TV program 201. Another set of cue-tones may be inserted to delimit a “chapter” (denoted 237) within a program. A chapter is a self-contained subprogram, e.g., a skit, monolog, song performance, news report, weather report, etc. within a program. With the cue-tones defining one such chapter, processor 109 is capable of identifying the chapter and create an asset concerning the same.

Let's assume that TV program 201 in this instance is an initial broadcast program. Processor 109, among other things, collects in a database (not shown) program guide data associated with different TV programs which are not pre-staged (including TV program 201 in this instance) from an application server, which may be different from the sources of the TV programs themselves. Each program when presented to processor 109 is identified by a program designation, which may be used to locate the corresponding program guide data. In particular, processor 109 while processing TV program 201 may locate the corresponding program guide data to create in real time the metadata file associated with TV program 201. The metadata file thus created includes such data as the title, rating (e.g., G, PG-13, R, etc.), names of the producer, director, and actors, duration of the program, program type (e.g., situation comedy), etc.

Processor 109 may also create in real time trick files associated with program 201 as part of the asset which are used to perform trick mode functions (e.g., pausing, rewinding and fast-forwarding) on program 201. One such trick file in this instance is a “fast-forward” trick file which contains an array of identifiers of I-frames in the program stream (MPEG-2 encoded as mentioned before) corresponding to program 201 in a forward direction. Another trick file is a “rewind” trick file which contains an array of identifiers of I-frames in the program stream corresponding to program 201 in the reverse direction. The I-frame identifiers in the trick files are used as indices or markers for rewinding and fast-forwarding of program 201. It should be noted that not all of the I-frames associated with program 201 are selected for the trick files. Rather, the I-frames are selected periodically along the program stream. Thus, the shorter the period is, the closer the instants from which program 201 can be rewound, and to which program 201 can be fast-forwarded, thereby achieving finer adjustments.

It should be noted that where program 201 is not an initial broadcast program, which may also be pre-staged, commercial segments 221 and 227 may not contain the commercials originally provided by the program provider. Rather, program 201 may be repackaged with after-market commercials, which may be targeted to the user, and which may even be injected anywhere in the program with no regard for original segments 221 and 227 in terms of their timing, duration, or quantity. In the event that program 201 is pre-staged, the program content comes with the corresponding metadata file and trick files associated with the program. Processor 109 stores the created or pre-staged asset including the metadata file and trick files associated with a program according to its program designation in asset storage (not shown), which may reside in library manager 113 described below.

The transport streams generated by processor 109, which contain live TV programs in this instance, are fed to cache manager 111. The latter includes a cache memory (not shown), e.g., a disk cache, having a memory capacity on the order of terabytes. Manager 111 copies the transport streams onto the cache memory, and also forwards the same to library manager 113 for long-term storage. The latter includes library storage having a memory capacity on the order of hundreds of terabytes, much larger than that of the cache memory such that the cache memory stores the last Y hours' worth of the TV programs while the library storage stores the last Z hours' worth of the TV program, where the value of Z is much greater than that of Y. It suffices to know for now that use of the cache memory, which affords faster access to its content than the library storage, facilitates a speedy retrieval of a requested program in the event of a “cache hit,” i.e., the requested program being within the last Y hour broadcast. Otherwise, a “cache miss” causes locating the requested program in the library storage, thereby incurring a delay in the retrieval of the program.

Network controller 125, among others, assigns resources for transporting program materials to set-top terminals and communicates various data including system information with the terminals. Upstream data from a set-top terminal to network controller 125 is communicated via a reverse passband, e.g., 5-40 MHz band, of a coaxial cable. The reverse passband comprises reverse data channels (RDCs) having a 1 MHz bandwidth in this instance, through which quaternary phase shift keying (QPSK) signals containing upstream data are transmitted. It should be noted that the 1 MHz bandwidth allocated for an RDC here is for illustrative purposes only. It will be appreciated that a person skilled in the art may allocate other bandwidths therefor depending on the actual implementations. A set-top terminal utilizes an RDC for sending both application data and control messages. For example, the Digital Audio Visual Council (DAVIC), a standard setting organization, has defined a contention-based access mechanism whereby multiple set-top terminals share an RDC. This mechanism enables the set-top terminals to transmit upstream messages without a dedicated connection to a QPSK demodulator. The mechanism also provides equal access to the set-top terminals that share the RDC, and enables detection and recovery from reverse path collisions that occur when two or more of the terminals transmit an upstream message simultaneously. As also specified by DAVIC, for communications purposes, the set-top terminals and network controller 125 are identified by the Internet protocol (IP) addresses assigned thereto. However, these IP addresses may be randomly assigned each time when system 100 is reconfigured. As a result, the IP address of a set-top terminal or controller 25 may change after a system reconfiguration. Nevertheless, each set-top terminal and controller 25 is also assigned a media access control (MAC) address on a permanent basis, surviving any system reconfiguration.

Downstream data from network controller 125 to a set-top terminal is communicated via forward data channels (FDCs). These channels, often referred to as “out-of-band” channels, may occupy the 70-130 MHz band of a coaxial cable. QPSK signals containing system messages to a set-top terminal are transmitted through an FDC having a 1 MHz bandwidth in this instance. It should be noted that the 1 MHz bandwidth allocated for an FDC here is for illustrative purposes only. It will be appreciated that a person skilled in the art may allocate other bandwidths therefor depending on the actual implementations.

When a user at a set-top terminal, say, terminal 158-1, turns on the TV associated therewith and selects a particular program channel, say, program channel 2, or change from another channel to channel 2, terminal 158-1 in a well known manner scans for any transport streams transporting programs to the neighborhood. In system 100, each transport stream is identified by a unique transport stream identification (TSID).

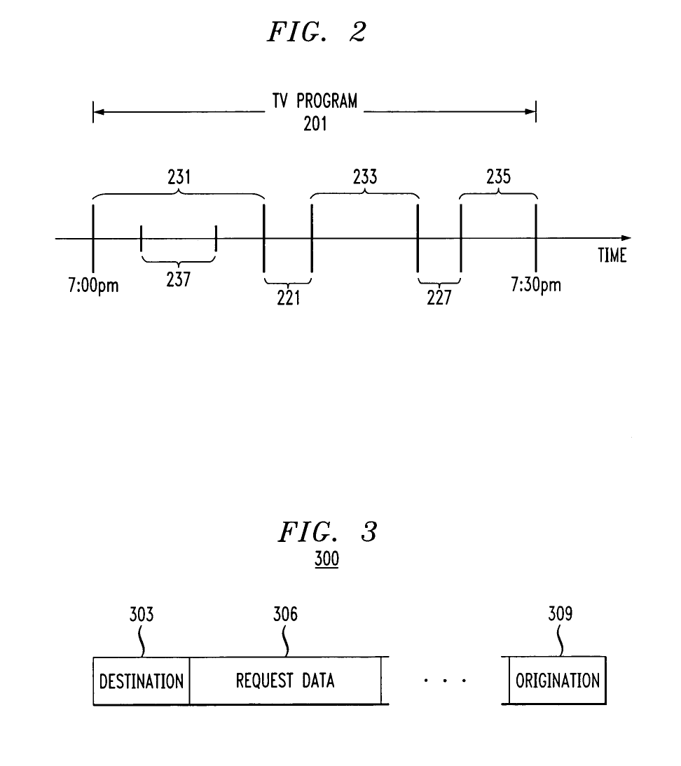

Continuing the above example, once the TSIDs of the transport streams are detected, terminal 158-1 sends through QPSK modem pool 127 a request for program channel 2 material. FIG. 3 illustrates one such request (denoted 300) sent from a set-top terminal to network controller 125 via an RDC. As shown in FIG. 3, request 300 includes, among others, destination field 303 which in this instance contains the IP address of network controller 125 for which request 300 is destined; request data field 306 which contains data concerning the detected TSIDs and the requested program channel material, e.g., program channel 2 material in this instance; and origination field 309 which in this instance contains the IP (and/or MAC) address of terminal 158-1 from which request 300 originates.

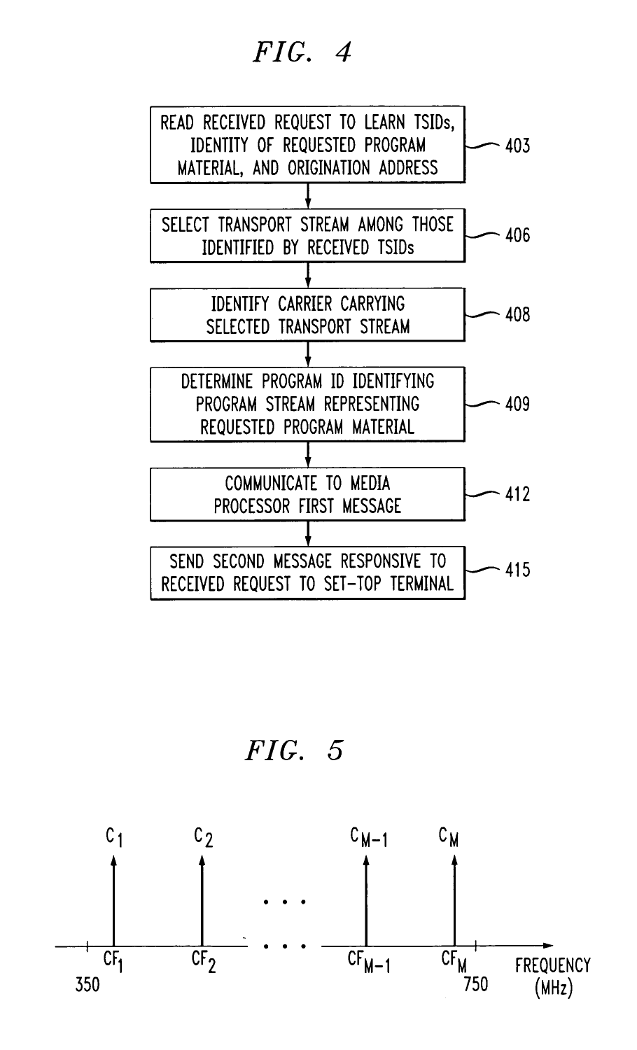

After receiving request 300, network controller 125 reads the received request to learn the TSIDs, the identity of the requested program material, and the origination address therein, as indicated at step 403 in FIG. 4. Network controller 125 communicates with media processor 119 to determine the capacity required for transmitting the requested program material. Based on the required capacity, controller 125 at step 406 selects a transport stream among those identified by the received TSIDs which is suitable for transporting the requested program material. Controller 125 at step 408 identifies the carrier carrying the selected transport stream.

Referring also to FIG. 1, modulator bank 123 in this instance is located in hub 120 connected to headend 105 via IP transport on the one hand and to HFC cable network 140 on the other hand. Bank 123 includes multiple modulators, each of which is used to modulate transport streams onto different carriers. Each modulated carrier carrying a transport stream is transmitted through a transmission channel associated therewith. FIG. 5 illustrates M carriers, C₁ through C_{M}, associated with M transmission channels in the forward passband. As shown in FIG. 5, the carrier frequency of C₁ is denoted CF₁; the carrier frequency of C₂ is denoted CF₂; . . . ; and the carrier frequency of C_{M} is denoted CF_{M}. In this example, each program stream may contain 4.2 Mb/s video and audio program data. By using a 256-quadrature-amplitude-modulation (256-QAM) technique and 6 MHz transmission channel, each modulator in modulator bank 123 in this instance may modulate 9 or more program streams, multiplexed in a transport stream, onto the corresponding carrier. The resulting modulated carrier is transmitted through the transmission channel associated with the carrier.

Network controller 125 may include therein a carrier assignment table which lists, for each carrier, the TSID of the transport stream carried thereby. The carrier identification by network controller 125 at aforementioned step 408 may be achieved by looking up from the table the carrier associated with the TSID of the selected transport stream. Based on the requested program channel, network controller 125 at step 409 determines the program ID identifying the program stream representing the requested program material, i.e., program channel 2 material in this instance, which is then multiplexed with other program streams in the selected transport stream. At step 412, network controller 125 communicates to media processor 119 a first message containing the identity of the modulator in modulator bank 123 which corresponds to the carrier, say, C₁, just determined, and the program ID associated with the requested program channel material just determined. Network controller 125 at step 415 sends, through QPSK modem pool 127, a second message responsive to the received request to set-top terminal 158-1 identified by the origination IP (and/or MAC) address in field 309 of request 300. This second message traversing an FDC contains the information concerning the carrier frequency, i.e., CF₁ in this instance, to which terminal 158-1 should tune to receive the appropriate transport stream, and the program ID for extracting the desired program stream, representing in this instance program channel 2 material, within the transport stream.

In response to the first message, processor 119 directs cache manager 111 to deliver a copy of the program stream representing the requested program channel material thereto and causes the program stream to be multiplexed with any other program streams already in the transport stream identified by the selected TSID. In addition, processor 119 causes switching unit 117 to switch the resulting transport stream to the modulator corresponding to the carrier C₁. Accordingly, the modulator modulates the carrier C₁ with the received transport stream, and causes transmission of the modulated carrier through the transmission channel associated with CF₁.

Based on the information in the second message, terminal 158-1 tunes to the carrier frequency CF₁ to receive the transmitted transport stream, and extracts therefrom the desired program stream, representing program channel 2 material in this instance. In a well known manner, terminal 158-1 converts the extracted program stream to appropriate signals for the associated TV to play program channel 2 material.

While the program channel 2 material is being played, terminal 158-1 continuously registers the last I-frame identifier in the received transport stream. From time to time, terminal 158-1 sends a “heartbeat” containing the IP (and/or MAC) address identifying terminal 158-1 and the last I-frame identifier to media processor 119. Processor 119 keeps, for terminal 158-1, a record identified by the IP (and/or MAC) address of terminal 158-1, and tracks the program being transmitted to terminal 158-1 and its I-frame progress. When processor 119 no longer receives heartbeats from terminal 158-1, e.g., because of an off state of the terminal, processor 119 may cause the transmission of the transport stream to terminal 158-1 to be halted.

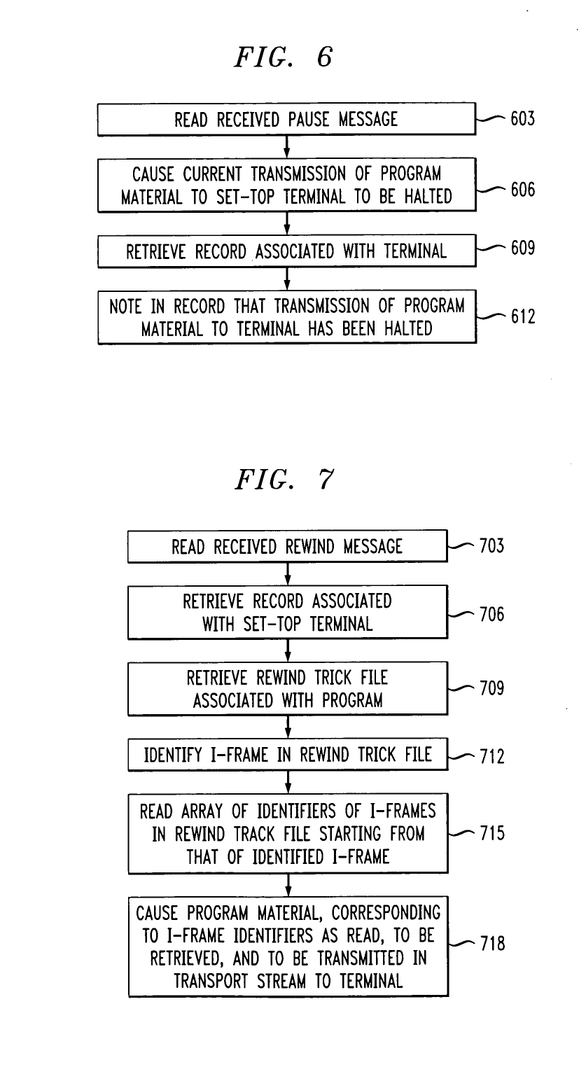

When the user issues a pause command to terminal 158-1, e.g., by pressing a “pause” key on a remote control associated therewith to temporarily stop the progress of the program, terminal 158-1 issues a pause message to media processor 119 identified by its IP address. The pause message in this instance includes a pause initiation command, the last I-frame identifier registered by terminal 158-1, and the IP and/or MAC address of terminal 158-1. After issuing the pause message, terminal 158-1 enters a pause state and causes the picture corresponding to the next I-frame, say I-frameₚₐᵤₛₑ, to be frozen on the TV screen, thereby achieving the pause effect. After receiving the pause message, processor 119 reads the received pause message, as indicated at step 603 in FIG. 6. Processor 119 at step 606 causes the current transmission of the program material to set-top terminal 158-1 (identified by the received IP and/or MAC address) to be halted at the I-frame immediately following the last I-frame identified in the received message. Processor 119 at step 609 retrieves the record associated with terminal 158-1. Processor 119 at step 612 notes in the record that the transmission of the program material to terminal 158-1 has been halted at I-frameₚₐᵤₛₑ.

When the user issues a command to resume viewing the program material, e.g., by toggling the pause key on the remote control, terminal 158-1 exits the pause state, sends a resumption message to processor 119, and readies itself to receive the program material starting from I-frameₚₐᵤₛₑ. This resumption message includes a resumption command, and the IP and/or MAC address of terminal 158-1. After reading the received resumption message, processor 119 retrieves the record associated with terminal 158-1 identified by the received IP and/or MAC address. In response to the resumption command, processor 119 causes the transmission of the program material to terminal 158-1 to be restarted from I-frameₚₐᵤₛₑ, and notes in the record the transmission resumption event. As a result, terminal 158-1 resumes receiving the program material in the same program stream delivered thereto before. It should be noted that use of a MAC address, instead of an IP address, to identify terminal 158-1 may be advantageous here especially when the pause state is long, so much so that a reconfiguration of system 100 may have occurred during such a state. In that case, the IP address identifying terminal 158-1 before the system reconfiguration may be different than that after the reconfiguration, and as a result, by using only the pre-reconfiguration IP address of terminal 158-1 for its identification, the resuming program stream would not be delivered to the intended terminal 158-1 after the reconfiguration. On the other hand, since the MAC address of terminal 158-1 is immutable and survives any system reconfiguration, by relying on the MAC address of terminal 158-1 for its identification here, the resuming program stream would be correctly delivered to terminal 158-1 even after a system reconfiguration.

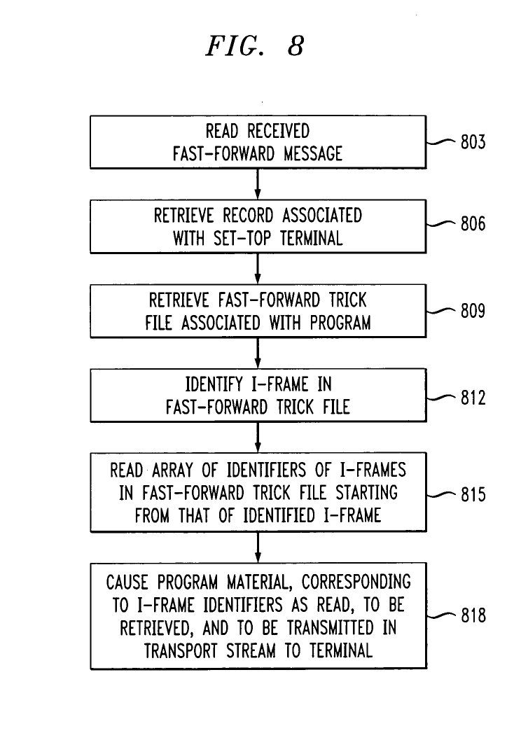

While viewing a program, the user may issue a rewind command, e.g., by pressing a rewind key on the remote control, to rewind the program. In that case, terminal 158-1 issues a rewind message to processor 119 identified by its IP address. This rewind message includes a rewind initiation command, the last I-frame identifier registered by terminal 158-1, and the IP address (and/or MAC address) identifying terminal 158-1. After receiving such a rewind message, processor 119 reads the received rewind message, as indicated at step 703 in FIG. 7. Processor 119 at step 706 retrieves the record associated with set-top terminal 158-1 identified by the received IP address (and/or MAC address). Knowing from the record the identity of the program being transmitted, processor 119 at step 709 retrieves from the aforementioned asset storage the rewind trick file associated with the program. Based on the last I-frame information in the received message, processor 119 at step 712 identifies the I-frame in the rewind trick file which either matches or is the closest to that last I-frame. Processor 119 at step 715 reads the array of identifiers of the I-frames in the rewind trick file starting from that of the identified I-frame. Processor 119 at step 718 causes the program material, corresponding to the I-frame identifiers as read, to be retrieved from cache manager 111, and to be transmitted in the transport stream to terminal 158-1, thereby achieving the desired rewind effect.

When the user issues a command to stop rewinding the program, e.g., by toggling the rewind key on the remote control, terminal 158-1 sends a rewind termination message to processor 119. This message includes a rewind termination command, and the IP address (and/or MAC address) of terminal 158-1. In response to the rewind termination command, processor 119 stops reading the rewind trick file associated with the program. Processor 119 learns from the record associated with terminal 158-1 the last I-frame identifier read from the rewind trick file. Processor 119 causes retrieval of the program material at the normal forward speed from cache manager 111 starting from the I-frame identified by the last read identifier, and transmission of the retrieved program material to terminal 158-1. As a result, terminal 158-1 resumes receiving the program material at the normal forward speed in the same transport stream.

After rewinding a program, the user may issue a fast-forward command, e.g., by pressing a fast-forward key on the remote control, to fast-forward the program. In that case, terminal 158-1 issues a fast-forward message to processor 119 identified by its IP address. This fast-forward message includes a fast-forward initiation command, the last I-frame identifier registered by terminal 158-1, and the IP address (and/or MAC address) identifying terminal 158-1. After receiving such a fast-forward message, processor 119 reads the received fast-forward message, as indicated at step 803 in FIG. 8. Processor 119 at step 806 retrieves the record associated with set-top terminal 158-1 identified by the received IP address (and/or MAC address). Knowing from the record the identity of the program being transmitted, processor 119 at step 809 retrieves from the aforementioned asset storage the fast-forward trick file associated with the program. Based on the last I-frame information in the received message, processor 119 at step 812 identifies the I-frame in the fast-forward trick file which either matches or is the closest to that last I-frame. Processor 119 at step 815 reads the array of identifiers of the I-frames in the fast-forward trick file starting from that of the identified I-frame. Processor 119 at step 818 causes the program material, corresponding to the I-frame identifiers as read, to be retrieved from cache manager 111, and to be transmitted in the transport stream to terminal 158-1, thereby achieving the desired fast-forward effect.

When the user issues a command to stop fast-forwarding the program, e.g., by toggling the fast-forward key on the remote control, terminal 158-1 sends a fast-forward termination message to processor 119. This message includes a fast-forward termination command, and the IP address (and/or MAC address) of terminal 158-1. In response to the fast-forward termination command, processor 119 stops reading the fast-forward trick file associated with the program. Processor 119 learns from the record associated with terminal 158-1 the last I-frame identifier read from the fast-forward trick file. Processor 119 causes retrieval of the program material at the normal forward speed from cache manager 111 starting from the I-frame identified by the last read identifier, and transmission of the retrieved program material to terminal 158-1. As a result, terminal 158-1 resumes receiving the program material at the normal forward speed in the same transport stream.

It should be pointed out at this juncture that in accordance with the invention, all or some of the programs afforded an NPVR service may not be afforded the fast-forward trick mode function to skip forward the program material in its presentation, as will be further described below.

It should also be pointed out at this juncture that in the above illustrative embodiment, the transport streams generated by processor 109, which contain, e.g., in-progress (or live) TV broadcast, are recorded in cache manager 111, followed by library manager 113, before they are fed to the requesting set-top terminals. As a result, the transport streams received by the terminals actually are recorded copies of the streams generated by processor 109. However, in another embodiment, the transport streams generated by processor 109 are fed to the requesting set-top terminals in real time, and at the same time switched to cache manager 111 and library manager 113 for recording thereof. Thus, in this other embodiment, when a user at a set-top terminal performs a trick mode function on an in-progress TV broadcast program, say, rewinding the program, the real-time transport stream being received by the terminal is immediately replaced by a second transport stream containing a recorded copy of the TV program, e.g., from cache manager 111. If after rewinding the program, the user invokes a fast-forwarding command to fast-forward the recorded TV program, there may come a point where the recorded TV program catches up with the in-progress program. In that case, the second transport stream being received by the terminal may be replaced back by the real-time transport stream containing the in-progress program.

Program/Program Channel Dependent NPVR Service

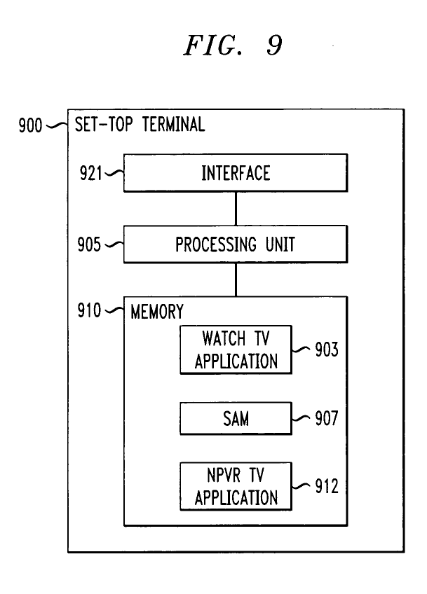

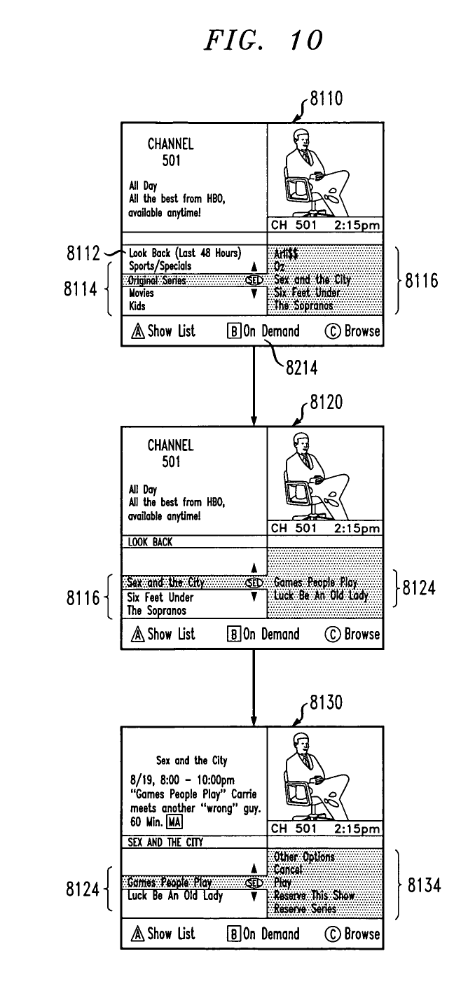

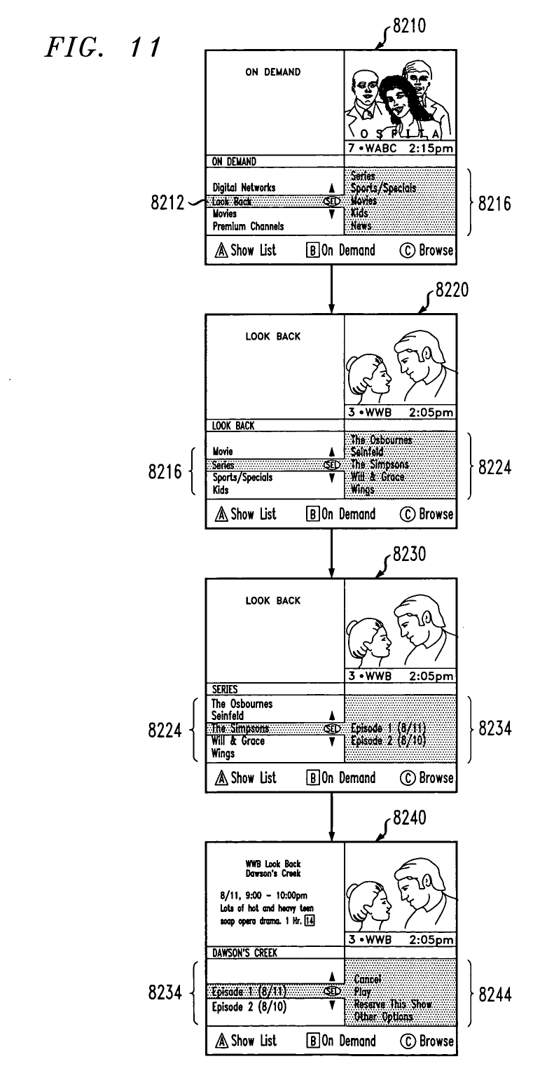

As mentioned before, selected program channels (or programs) may be afforded the above-described NPVR service while the rest of the program channels (or programs) may be afforded the traditional broadcast service. A conventional “Watch TV” application (denoted 903 in FIG. 9) is installed in a set-top terminal (denoted 900) to service those program channels (or programs) afforded the traditional broadcast service. It should be noted that set-top terminal 900 here generically represents one of set-top terminals 158-1 through 158-L. Watch TV application 903, residing in memory 910, provides such well known functions as channel navigation control, channel selection in response to a channel change event, etc. A channel change event occurs when a user at set-top terminal 900 issues a command to change from one program channel to another. Such a command may be issued, say, using a remote control (not shown), which signal is receptive by set-top terminal 900. Memory 910 in this instance comprises one or more caches, disks, hard drives, NVRAMs, DRAMs, Flash ROMs, and/or ROMs.

For example, in memory 910, NVRAM may be used for storage of a user's settings and set-top terminal configuration settings, such as parental control codes, favorite channel lineups, set-top terminal setups, channel maps, authorization tables, and FDC address assignments. DRAM may be used for most application and operating system storage requirements, such as stacks, heaps, graphics, interactive program guide data, marketing data and usage data, and functions such as MPEG-2 video decompression, AC-3 audio decoding, and video manipulation. ROM may be used for storage of the operating system. Flash ROM may be used for storage of resident application software, as well as patches of the operating system and application software which are downloaded to set-top terminal 900 from headend 105 after set-top terminal 900 has been deployed at the user's premises.

Processing unit 905 orchestrates the operations of set-top terminal 900. It executes instructions stored in memory 910 under the control of the operating system. Service application manager (SAM) 907 forms part of such an operating system of terminal 900. SAM 907 is responsible for, among other things, monitoring channel change events; administering channel, service and other tables in terminal 900; and maintaining a registry of applications in terminal 900. One such application is aforementioned Watch TV application 903 which is invoked to service a traditional broadcast channel (or program). Another application is “NPVR TV” application 912 which is invoked to service NPVR enabled channels (or programs), and which may be downloaded from headend 105 to memory 910. Application 912, among others, responds to rewind, pause and fast-forward commands initiated by a user, and communicates such commands to headend 105 through interface 921 to perform the trick mode (i.e., rewind, pause and fast-forward) functions on programs in the manner described before, with exception to selected programs which are not afforded the fast-forward trick mode capability, in accordance with the invention. In addition, for example, application 912 not only allows a user to reserve future broadcast programs for review, but also reserve, play or restart programming content that has broadcast, in accordance with a “Look Back” feature.

### NPVR Service Look Back Feature

The Look Back feature enables a user to access programming content that has broadcast during a “Look Back Period”—i.e., up to a predetermined period. The actual length of the period is subject to the negotiated rights to the programming content. Specifically, the Look Back feature enables a user to restart an NPVR program that is currently being broadcast. The Look Back feature also enables a user to play an NPVR program that was previously broadcast within the Look Back Period (e.g., the previous two days). In addition, the Look Back feature enables a user to reserve an NPVR program in its entirety that is presently being broadcast or that was previously broadcast within the Look Back Period for subsequent viewing or archiving.

Programs that are available through the Look Back feature may be accessed for viewing or reserving in several ways. For example, a Look Back menu may be accessed when viewing content on an NPVR enabled channel which, in effect, gives that channel an on-demand-like feature. Thus, by accessing a Look Back menu, the viewer may be presented with a categorical listing of all programs that are available for either (1) immediate viewing, or (2) reservation for subsequent viewing. Therefore, the Look Back feature provides a user with the ability to play or reserve previously (or currently) broadcast programs, but does not require the user to denote such programs in advance as a favorite, or to otherwise proactively elect to reserve the program.

Programs that are available through the Look Back feature may be accessed by a listing that may be organized by channel, by reverse chronological order (or chronological order), by theme (movies, sports, drama, etc.), by alphabetical order, etc. The Look Back feature may be made available while a user is viewing a program on an NPVR enabled channel. Turning to FIG. 10, while a user is viewing, e.g., a program on program channel 501 (an NPVR enabled channel in this instance), Look Back feature option 8112 is offered on graphical user interface (GUI) 8110 after the user presses, say, a menu key on a remote control. A selection of option 8112 in this instance allows the user to access past programs broadcast on the same channel (i.e., program channel 501 being viewed by the user) within the Look Back Period. Specifically, by highlighting the Look Back feature option 8112 and pressing, say, a select key on the remote control, a list of programming categories, denoted 8114 are displayed under selected Look Back feature option 8112. These categories may include sports programming, specials, original series, movies, kids programming. By highlighting a program category from list 8114, another list of available programs, denoted 8116, is displayed on GUI 8110.

Upon selecting a program category by pressing the select key on the remote control, Look Back Programming GUI 8120 lists programs 8116 that are available on program channel 501 for the program category that was selected. programs 8116 are listed on the left side of GUI 8120. As the user highlights a listed program, episodes 8124 that are available through the Look Back feature are listed on the right side of GUI 8120.

Upon selecting a program by pressing the select key on the remote control, Look Back Episode GUI 8130 lists episodes 8124 that are available on program channel 501 for the program that was selected. These episodes 8124 are listed on the left side of Look Back GUI 8130. As the user highlights a listed episode, the reservation/play options 8134 that are available through the Look Back feature are listed on the right side of GUI 8130. These features may include, for example, canceling the Look Back feature request, playing the selected episode, reserving the selected episode and reserving the entire series (i.e., season pass).

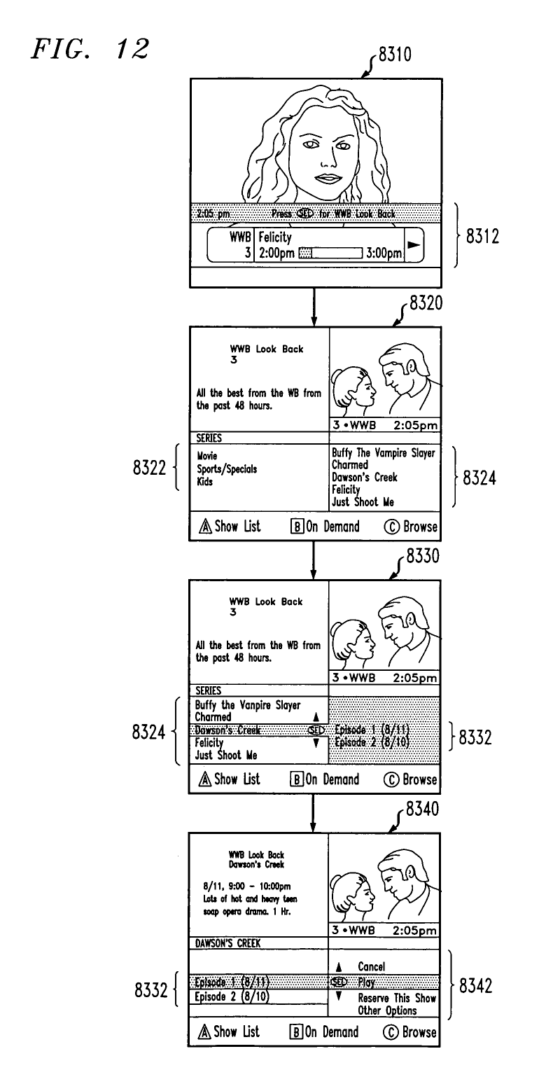

A Global Look Back feature may also be implemented. The Global Look Back feature enables a user to access a program previously broadcast even if the user does not know on which channel it was broadcast. As illustrated in FIG. 11, the Global Look Back feature displays programs from one or more databases of all NPVR enabled channels providing Look Back-enabled access during a given Look Back period (e.g., two days into the past). For example, Look Back option 8212 is displayed upon accessing On-Demand option 8214 of GUI 8110. By highlighting Look Back option 8212, a list of categories of available Look Back programs, denoted 8216, is displayed on the right side of GUI 8210. These categories include, e.g., TV show series, sports programming, specials, movies, kids programming and news.

Upon selecting Look Back option 8212 by pressing the select key on the remote control, Look Back Program Categories GUI 8220 is displayed. The available program categories 8216 are illustratively listed on the left side of GUI 8220. By highlighting a listed program category, a list of available programs, denoted 8224, is displayed on the right side of GUI 8220.

Upon selecting a program category by pressing the select key of the remote control, Look Back Programming GUI 8230 lists the programs 8224 that are available for the program category that was selected. These programs 8224 are illustratively listed on the left side of GUI 8230. As the user highlights a listed program, episodes 8234 that are available through the Look Back feature are listed on the right side of GUI 8230.

Upon selecting a program by pressing the select key on the remote control, Look Back Episode GUI 8240 lists, on the left side of GUI 8240, episodes 8234 that are available on the displayed On-Demand channel for the program that was selected. As the user highlights a listed episode, the reservation/play options 8244 that are available through the Look Back feature are listed on the right side of GUI 8240. These features may include, for example, canceling the Look Back feature request, playing the selected episode, reserving the selected episode, etc.

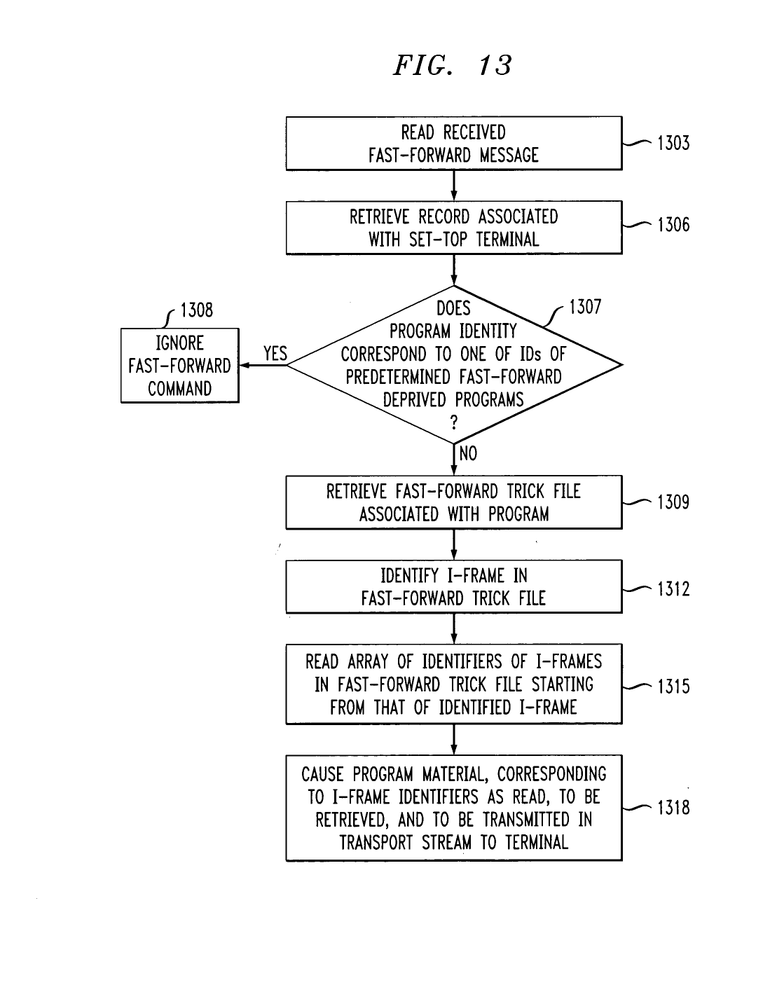

The Look Back feature may also be made available through an information banner, from which a show within the Look Back period could be selected for playing or reservation. Referring to FIG. 12, information banner 8332, illustratively in the form of a rectangular bar, contains information about a program that is being viewed by a user. The information banner may be displayed, e.g., when the user tunes to an NPVR enabled channel. The information includes the present time, the broadcast time (beginning and ending times), the channel on which the program is broadcast, etc. As indicated by GUI 8310, also provided by banner 8332 is a message indicating the availability of the Look Back feature for programming offered by the currently viewed channel.

By pressing the select key on the remote control, Look Back (program categories) GUI 8320 is displayed. The available program categories, denoted 8322, are illustratively listed on the left side of GUI 8320. By highlighting a listed program category, a list of available programs for such category, denoted 8324, is displayed on the right side of GUI 8320.

Upon selecting a program category by pressing the select key of the remote control, Look Back Programming GUI 8330 lists programs 8324 that are available for the program category that was selected. These programs 8324 are illustratively listed on the left side of GUI 8330. As the user highlights a listed program, episodes 8332 that are available through the Look Back feature are listed on the right side of GUI 8330.

Upon selecting a program by pressing the select key on the remote control, Look Back Episode GUI 8340 lists, on the left side of GUI 8340, episodes 8332 that are available for the selected program. As the user highlights a listed episode, reservation/play options 8344 that are available through the Look Back feature are illustratively listed on the right side of GUI 8340. These features may include, for example, canceling the Look Back feature request, playing the selected episode, reserving the selected episode, etc.

### Inventive Services Including the PTOD Service

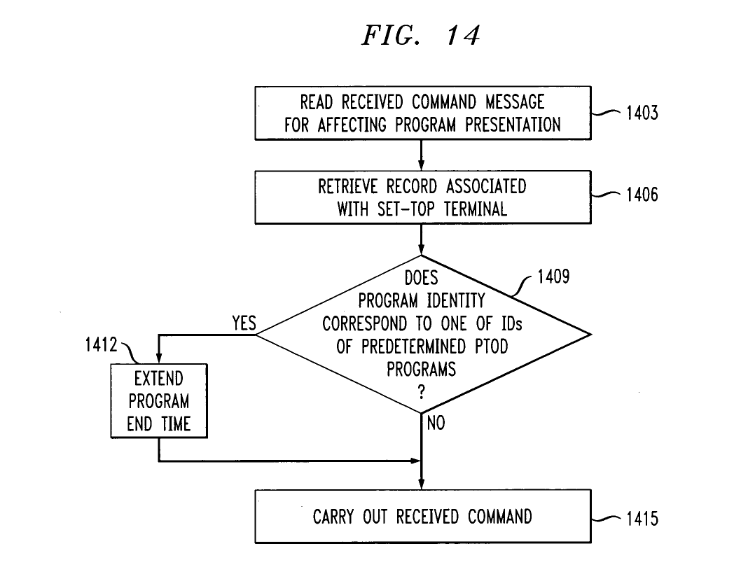

As mentioned before, in accordance with an aspect of the invention, all or some of the NPVR programs may be deprived of the fast-forward capability otherwise afforded by the NPVR service. Such fast-forward deprived programs may be predetermined programs in a prime time lineup, which may be identified by their program IDs. When a user at terminal 900 issues a fast-forward command, e.g., by pressing a fast-forward key on the remote control, to fast-forward an NPVR program, terminal 900 issues a fast-forward message to media processor 119 identified by its IP address. This fast-forward message includes a fast-forward initiation command, the last I-frame identifier of the program registered by terminal 900, and the IP address (and/or MAC address) identifying terminal 900. Referring to FIG. 13 similar to FIG. 8, after receiving such a fast-forward message, processor 119 reads the received fast-forward message, as indicated at step 1303. Processor 119 at step 1306 retrieves the record associated with set-top terminal 900 identified by the received IP address (and/or MAC address). Knowing from the record the identity of the program being transmitted, processor at step 1307 determines whether the program identity corresponds to one of the IDs of the predetermined, fast-forward deprived programs. If so, processor 119 at step 1308 ignores the fast-forward initiation command, resulting in no fast-forward effect on the program presentation. Otherwise, processor 119 at step 1309 retrieves from the aforementioned asset storage the fast-forward trick file associated with the program. Based on the last I-frame information in the received message, processor 119 at step 1312 identifies the I-frame in the fast-forward trick file which either matches or is the closest to that last I-frame. Processor 119 at step 1315 reads the array of identifiers of the I-frames in the fast-forward trick file starting from that of the identified I-frame. Processor 119 at step 1318 causes the program material, corresponding to the I-frame identifiers as read, to be retrieved from cache manager 111, and to be transmitted in the transport stream to terminal 900, thereby achieving the desired fast-forward effect.

In accordance with another aspect of the invention, all or some of the programs on an NPVR enabled channel may be subject to the PTOD service. Such PTOD programs may be predetermined programs in a prime time lineup, which a user may not be allowed to time-shift for later viewing otherwise allowed by the above-described NPVR service Look Back feature. In a first scenario where while a user is watching a PTOD program during its broadcast according to the broadcast schedule (e.g., from 8:00 pm to 9:00 pm), the user issues no restart or trick mode command to affect the program presentation, the PTOD program will end according to the broadcast schedule (i.e., 9:00 pm). Since, in accordance with the PTOD service, a user is denied the Look Back feature to later review a previously broadcast PTOD program, the user's experience in the first scenario is as if he/she watched a regular scheduled program on a traditional broadcast channel.

In a second scenario where a user issues a restart or trick mode command to affect a presentation of a PTOD program during its broadcast (i.e., from 8:00 pm to 9:00 pm), the end time of the PTOD program may be extended beyond the broadcast schedule in accordance with the invention, e.g., by an hour after the scheduled end time (i.e., 9:00 pm +1 hour=10:00 pm in this instance). In this second scenario, referring to FIG. 14, after receiving a command message for affecting a program presentation from terminal 900, processor 119 reads the received command message, as indicated at step 1403. Processor 119 at step 1406 retrieves the record associated with set-top terminal 900 identified by the IP address (and/or MAC address) in the received message. Knowing from the record the identity of the program being transmitted, processor at step 1409 determines whether the program identity corresponds to one of the IDs of the predetermined PTOD programs. If so, processor 119 at step 1412 extends the end time of the program, e.g., by an hour. That is, for this particular terminal 900, processor 119 prolongs transmission of the PTOD program content thereto till 10:00 pm, during which the program is afforded the NPVR service features, including the trick mode, and restart functions, but not the Look Back feature for time-shifting the program. In other words, a user in this instance is denied the Look Back feature to revisit the PTOD program after its extended end time, i.e., 10:00 pm. It should be noted that unless the PTOD program is also designated a fast-forward deprived program, the fast-forward function remains effective. It should also be noted that the program end-time extension afforded by processor 119 may be terminated at anytime by the user pressing a first predetermined key, e.g., a STOP key, on a remote control associated with terminal 900, to rejoin the program being broadcast on the same channel, or a second predetermined key to view the program which was broadcast immediately after the PTOD program in question.

The subject routine proceeds from step 1412 to step 1415 described below. Otherwise, if it is determined at step 1409 that the program identity does not correspond to one of the IDs of the predetermined PTOD programs, the subject routine proceeds from step 1409 to step 1415 directly, where processor 119 carries out the received command to affect the presentation of the program as desired by the user.

However, there is a chance that a user may rewind a PTOD program too far to be able to finish the program by its extended end time. For example, let's say the duration of a PTOD program is an hour long, which is scheduled for broadcast from 8:00 pm to 9:00 pm. Because the user issues a command to manipulate the presentation of the program during its broadcast, the end time of the program is extended to 10:00 pm, in accordance with the PTOD service. If the user, say, at 9:30 pm rewinds more than a half-hour's worth of program content, the user cannot reach the end of the program by 10:00 pm at the normal play speed (i.e., without fast-forwarding to skip any program content). Thus, it is desirable to alert the user, while rewinding, at the point of the program beyond which the user will not be able to finish the program by the extended end time. The alert may be generated and inserted into the program transmission by media processor 119, and may comprise a display of such warning as “You will not be able to finish this program if you rewind past this point.” To properly insert one such alert, the program may be indexed according to Normal Play Time (NPT) which, for example, may start at zero, progress in milliseconds, and assume no negative value. The length of time between an NPT start time and an NPT end time corresponds to the actual duration of the program. As mentioned before, the actual duration of the program is indicated in metadata associated with the program. It is understood, however, that the NPT is an organizational tool, and that the NPT may be an arbitrary index. It is also understood that other indexing schemes may be used, instead.

In this instance, A/S processor 109 (or another processor in headend 105) indexes a program to be broadcast with an NPT value starting at zero, with an increment of a millisecond. Take the above-described PTOD program for example, whose duration is an hour or 3,600,000 milliseconds. The NPT index at the end of such a program has a value of 3600000.

Processor 119 determines the NPT index of the PTOD program at which the aforementioned alert is inserted (NPTₐₗₑᵣₜ) as follows:
NPTₐₗₑᵣₜ=[PD−(EET−CurTime)] in milliseconds, (1)
where PD represents the program duration; EET represents the extended end time; and CurTime represents the current time indicated by a system clock (not shown) in headend 105. Since an NPT cannot be a negative value, processor 119 inserts no alert if the NPTₐₗₑᵣₜ value from expression (1) is negative.

Similarly, processor 119 may insert an alert, warning a user that he/she may not be able to finish the PTOD program by the extended end time, before the user can restart the program given the following condition:
PD−(EET−CurTime)>0. (2)

In addition, for the convenience of a user, while a user is viewing a PTOD program whose end time has been extended in accordance with the invention, he/she may be able to learn the remaining play time of such a PTOD program by pressing a predetermined key, e.g., an INFO key, on a remote control. In response, processor 119 determines the remaining play time (RPT) as follows and causes such information to be presented on the user's TV screen (e.g., expressed in minutes and seconds):
RPT=PD−NPT_{current}, (3)
where NPT_{current} represents the NPT index of the PTOD program at which the user is viewing. Processor 119 may also cause an allowable remaining view time (ARVT) to be displayed so that the user, by comparing the ARVT with the RPT, can budget his/her time to finish the PTOD program by its extended end time, where
ARVT=EET−CurTime. (4)

The foregoing merely illustrates the principles of the invention. It will thus be appreciated that those skilled in the art will be able to devise numerous other arrangements which embody the principles of the invention and are thus within its spirit and scope.

For example, the PTOD service described above may be supplemented with a “Recently Aired” option, selection of which allows a user to view recently aired programs which are defined by the cable operator, subject to negotiated rights to such programs.

In addition, in another embodiment, a PTOD time window is imposed while a user is viewing a PTOD program whose end time has been extended. In accordance with this embodiment, trick mode functions (e.g., rewind, fast-forward, pause, etc.) are effective only during such a PTOD time window, which is a limited time period within the extended PTOD program time. That is, after the PTOD time window expires, processor 119 ignores any trick mode command initiated by the user, and thereby disables the trick mode functionality, for the remainder of the PTOD program. However, before the PTOD time window expires, an alert message may be transmitted by processor 119 to warn the user that the time window is about to expire and that the user would lose the trick mode functionality for the remainder of the PTOD program.

Further, in the disclosed embodiment the network transport is illustratively realized using HFC cable network 140. However, other networks such as digital subscriber line (DSL) networks, ethernet networks and satellite networks may be used instead.

Finally, system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A system for providing a service receptive to a fast-forward command for fast-forwarding a program on a program channel in a presentation thereof, the system comprising:
a mechanism for providing a plurality of programs on a selected program channel, a subset of the programs being identified;
an interface for receiving a fast-forward command from a device for presenting a selected program on the selected program channel to a user; and
a processor for determining whether the selected program is one of the identified programs in the subset, the processor being unresponsive to the fast-forward command if it is determined that the selected program is one of the identified programs in the subset.

2. The system according to claim 1, wherein the identified programs in the subset are selected based on times of broadcast thereof.

3. The system according to claim 2, wherein the identified programs in the subset are in a prime time lineup.

4. The system according to claim 1, wherein the selected program is punctuated with one or more commercials.

5. The system according to claim 1, wherein the selected program contains one or more product placement advertisements.

6. The system according to claim 1, comprising a broadband communications system.

7. The system according to claim 6, wherein the broadband communications system includes a cable TV system.

8. The system according to claim 7, wherein the device includes a set-top terminal.

9. A system for providing programming content over a communications network, comprising:
a mechanism for delivering a plurality of programs on a selected program channel according to a broadcast schedule, a subset of the plurality of programs being identified;
an interface for receiving from a device over the communications network a command for manipulating a presentation of a selected program on the selected program channel, the device being used for presenting the selected program to a user; and
a processor responsive to the command when received during a broadcast of the selected program for determining whether the selected program is one of the identified programs in the subset, a presentation time of the selected program presented using the device being adjusted as a function of the broadcast schedule if it is determined that the selected program is one of the identified programs in the subset.

10. The system according to claim 9, wherein the presentation time is extended to end the presentation of the selected program past a scheduled end time in accordance with the broadcast schedule.

11. The system according to claim 9, further comprising a mechanism for providing to the device information concerning remaining play time of the selected program after the presentation time thereof is adjusted.

12. The system according to claim 9, further comprising a mechanism for providing to the device information concerning remaining view time of the selected program after the presentation time thereof is adjusted.

13. The system according to claim 9, wherein the command does not include a fast-forward command.

14. The system according to claim 10, wherein the command includes a rewind command, and an alert is issued when the selected program is being rewound past a selected point thereof, the selected point being selected as a function of at least the extended presentation time.

15. The system according to claim 14, wherein the alert includes a display of a warning.

16. The system according to claim 10, wherein the command includes a restart command, and an alert is issued as a function of at least a duration of the selected program and the extended presentation time.

17. The system according to claim 16, wherein the alert includes a display of a warning.

18. The system according to claim 9, wherein the identified programs in the subset are selected based on times of broadcast thereof.

19. The system according to claim 18, wherein the identified programs in the subset are in a prime time lineup.

20. The system according to claim 9, wherein the communications network includes a broadband communications network.

21. The system according to claim 20, wherein the broadband communications network includes a cable TV network.

22. The system according to claim 21, wherein the device includes a set-top terminal.

23. A method for providing a service receptive to a fast-forward command for fast-forwarding a program on a program channel in a presentation thereof, the method comprising:
providing a plurality of programs on a selected program channel;
identifying a subset of the programs;
receiving a fast-forward command from a device for presenting a selected program on the selected program channel to a user;
determining whether the selected program is one of the identified programs in the subset; and
not responding to the fast-forward command if it is determined that the selected program is one of the identified programs in the subset.

24. The method according to claim 23, wherein the identified programs in the subset are selected based on times of broadcast thereof.

25. The method according to claim 24, wherein the identified programs in the subset are in a prime time lineup.

26. The method according to claim 23, wherein the selected program is punctuated with one or more commercials.

27. The method according to claim 23, wherein the selected program contains one or more product placement advertisements.

28. The method according to claim 23, wherein the service comprises a broadband communications service.

29. The method according to claim 28, wherein the broadband communications service includes a cable TV service.

30. The method according to claim 29, wherein the device includes a set-top terminal.

31. A method for providing programming content over a communications network, comprising:
delivering a plurality of programs on a selected program channel according to a broadcast schedule;
identifying a subset of the plurality of programs;
receiving from a device over the communications network a command for manipulating a presentation of a selected program on the selected program channel, the device being used for presenting the selected program to a user; and
in response to the command when received during a broadcast of the selected program, determining whether the selected program is one of the identified programs in the subset, a presentation time of the selected program presented using the device being adjusted as a function of the broadcast schedule if it is determined that the selected program is one of the identified programs in the subset.

32. The method according to claim 31, wherein the presentation time is extended to end the presentation of the selected program past a scheduled end time in accordance with the broadcast schedule.

33. The method according to claim 31, further comprising providing to the device information concerning remaining play time of the selected program after the presentation time thereof is adjusted.

34. The method according to claim 31, further comprising providing to the device information concerning remaining view time of the selected program after the presentation time thereof is adjusted.

35. The method according to claim 31, wherein the command does not include a fast-forward command.

36. The method according to claim 32, wherein the command includes a rewind command, and an alert is issued when the selected program is being rewound past a selected point thereof, the selected point being selected as a function of at least the extended presentation time.

37. The method according to claim 36, wherein the alert includes a display of a warning.

38. The method according to claim 32, wherein the command includes a restart command, and an alert is issued as a function of at least a duration of the selected program and the extended presentation time.

39. The method according to claim 38, wherein the alert includes a display of a warning.

40. The method according to claim 31, wherein the identified programs in the subset are selected based on times of broadcast thereof.

41. The method according to claim 40, wherein the identified programs in the subset are in a prime time lineup.

42. The method according to claim 31, wherein the communications network includes a broadband communications network.

43. The method according to claim 42, wherein the broadband communication network includes a cable TV network.

44. The method according to claim 43, wherein the device includes a set-top terminal.
